(19) United States
(12) Patent Application Publication
(10) Pub. No.: US 2023/0351513 A1
(43) Pub. Date: Nov. 2, 2023

(54) SYSTEM, METHOD, AND APPARATUS FOR AGGREGATING VOTES FOR SECURITIES OF A COMPANY

(71) Applicant: Amir Ehsan Khandani, New York, NY (US)

(72) Inventor: Amir Ehsan Khandani, New York, NY (US)

(21) Appl. No.: 17/733,806

(22) Filed: Apr. 29, 2022

(51) Int. Cl. G06Q 40/06; G06Q 50/00

(52) U.S. Cl. CPC G06Q 40/06; G06Q 50/01; G06Q 2230/00

(57) ABSTRACT

An apparatus configured to and a method include registering user ownership of securities of a company, receiving and storing identified topics of interest from registered users who own securities of the company, identifying a voting item associated with the company, assigning a topic to the voting item, providing the voting item and the assigned topic to the registered users who own securities of the company, receiving, from the registered users, votes related to the voting item, and conveying the received votes to the company via one or more voting agents.

### FIELD

The present disclosure relates to voting related to shares of securities held by investors by an electronic voting system. In particular, the present disclosure relates to systems, apparatus, and methods for electronic voting related to shares of securities by collecting voting decisions from investors.

### BACKGROUND

Public companies are required to hold frequent meetings for their shareholders, for example, an annual general meeting (AGM) for United States companies, during which shareholders are provided with the opportunity to vote on issues of importance to the company’s business. Some issues may be similar across many companies and may frequently recur, for example, voting for individuals nominated to be on the company’s board of directors. Other issues may be situation or company-specific, for example, issues addressing particular policies of a firm related to environment or labor or the company’s business structures and procedures.

An item, also known as a voting item, is put to a shareholder’s vote at the AGM. Voting items may not be readily apparent to shareholders. Shareholders may not be able to attend such meetings in person due to distance, scheduling conflicts, or lack of time needed to attend an AGM. Shareholders may be unaware of mechanisms other than in-person voting for making their voice heard on voting items. Easier ways for shareholder voting than in-person voting are desirable.

### SUMMARY

One or more embodiments include an apparatus configured to and a method comprising registering user ownership of securities of a company, receiving and storing identified topics of interest from registered users who own securities of the company, identifying a voting item associated with the company, assigning a topic to the voting item, providing the voting item and the assigned topic to the registered users who own securities of the company, receiving, from the registered users, votes related to the voting item, and conveying the received votes to the company via one or more voting agents.

### BRIEF DESCRIPTION OF THE DRAWINGS

FIG. 1 illustrates a diagram of a system and entities involved in purchasing and voting in securities for a company in accordance with at least one embodiment.

FIG. 2 illustrates an electronic voting system in accordance with at least one embodiment.

FIG. 3 is a flowchart illustrating a method for voting involving inhouse brokers in accordance with at least one embodiment.

FIG. 4 is a flowchart illustrating a method for voting involving partner brokers in accordance with at least one embodiment.

FIG. 5 is a flowchart illustrating a method for purchase of shares and registration of investors as members in an electronic voting system in accordance with at least one embodiment.

FIG. 6 is a flowchart illustrating a method for identifying topics of interest and voting cohort groups for voting items in accordance with at least one embodiment.

FIG. 7 is a flowchart illustrating a method for obtaining and determining voting decisions for a voting item in accordance with at least one embodiment.

FIG. 8 is a flowchart illustrating a method for conveying voting information to a tally agent in accordance with at least one embodiment.

FIG. 9 is a flowchart illustrating a method for conveying voting information to a asset manager in accordance with at least one embodiment.

FIG. 10 is a flowchart illustrating a method for conveying voting information to a ballot agent in accordance with at least one embodiment.

FIG. 11 is a flowchart illustrating a method for borrowing shares of a security and conveying voting information for the security in accordance with at least one embodiment.

FIG. 12 is a diagram illustrating a layout for a news feed for voting items presented to a registered user on a display in accordance with at least one embodiment.

FIG. 13 is a diagram illustrating a layout for social interactions related to a voting item and presented to a registered user on a display in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments herein.

The apparatus and method components have been represented where appropriate by conventional symbols in the drawings, showing only those specific details that are pertinent to understanding the embodiments of the present embodiments so as not to obscure the disclosure with details that will be readily apparent to those of ordinary skill in the art having the benefit of the description herein.

### DETAILED DESCRIPTION

The present description discloses techniques for multi-factor authentication to verify a user and/or user devices. A system is described provides individual investors with the ability to aggregate the voting power of their investments. The system includes a social element where individual investors registered in the system are notified about issues being put to vote based on their investments and preferences. The system facilitates the social element by capturing data related to issues being put to vote by corporations and validating, enriching, and categorizing that data. In one embodiment, the registered investors may join voting cohort groups based on their views on how corporations should be run, including their views on the Environmental, Social, and Governmental (ESG) issues in corporate governance. The system allows for the aggregation of vote for the shares registered investors hold directly and those investors indirectly hold via investment in vehicles such as Exchange Traded Funds (ETFs). The system also facilitates the registration of the registered users’ votes at the annual meeting of the corporations through a variety of methods, including interacting with the existing proxy voting infrastructure, conveying the voting decisions to ETF managers, or using synthetic methods such as borrowing shares solely for the purpose of voting the shares.

Currently, information about investment voting, while available in various places, is not easily consumable by general investors. The system provides a social network built around the interactions between investors to learn about, discuss, and eventually vote their views on various topics. Increased corporate responsibility and shareholder engagement may result.

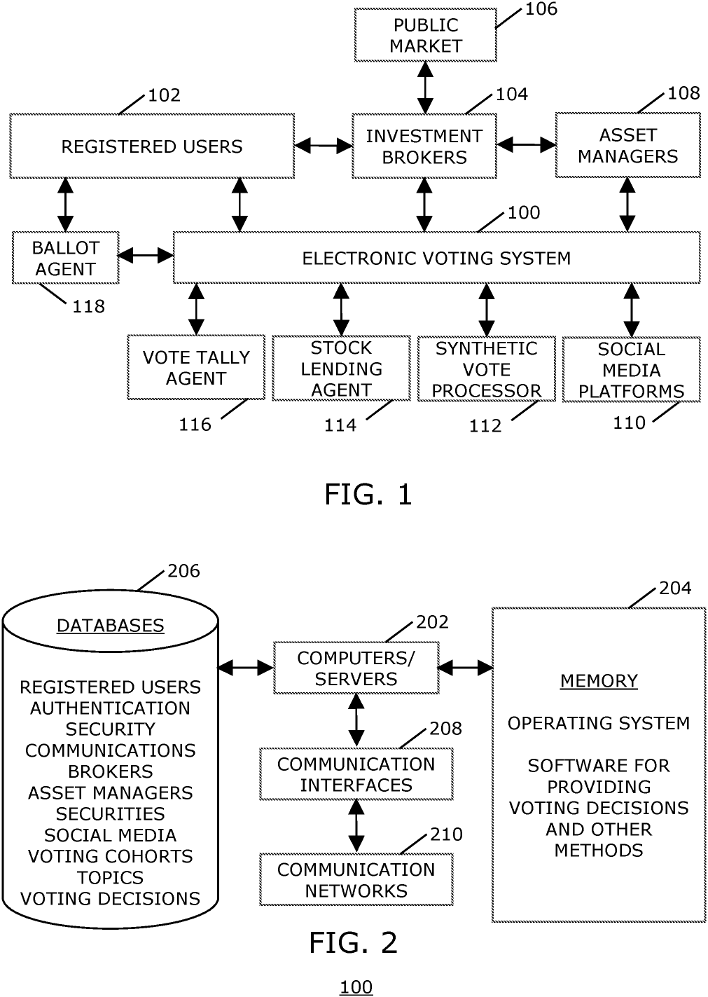

A diagram of a system and entities involved in purchasing and voting in securities for a company is illustrated in FIG. 1. An electronic voting system 100, as referred to herein simply as a system, interacts with electronic devices utilized by registered users 102 of the system 100 to communicate information. Registered users 102 may refer to a human being as well as their associated electronic devices. Electronic devices include, but are not limited to, computers, servers, laptops, cellular phones, digital assistants, and so forth. An investor who purchases an investment, such as a security in a company or other votable investment, and registers with the system is referred to as a registered user or member. Registered users 102 may interact with each other through the system 100. The system 100 communicates with electronic devices of one or more investment brokers 104, including third-party or partner brokers and inhouse brokers operated by the same entity that operates the system 100, that purchase and sell investments such as securities in a company from a public market 106 such as a securities exchange. The system 100 communicates with electronic devices of one or more asset managers 108 that hold investments such as ETFs or mutual funds for investors. The system 100 communicates with electronic devices such as servers of social media platforms 110 including the internet, websites of companies that issue securities, general social media websites, and other social media outlets. The system 100 communicates with electronic devices of a synthetic vote processor 112 and a stock lending agent 114 to borrow stock to produce a synthetic vote. A synthetic vote involves, for example, a process of borrowing shares from a stock lending agent to hold on the stock record date solely for the purpose being the holder of record to have the ability to vote the borrowed shares. The synthetic vote processor 112 may be integrated in the system 100 or may be part of a third-party entity. A stock lending agent 114 refers to a firm that is active in a stock lending market on behalf of beneficial owners of stocks. The system 100 also communicates with electronic devices of a vote tally agent 116, which refers to a firm hired by a company to tally their votes at the AGM. The system 100 communicates with electronic devices of a ballot agent 118, which refers to a firm hired by investment brokers to produce ballots for shareholders and collect the resulting votes. Communications between various entities may be wired or wireless communications as known in the industry.

An electronic voting system is illustrated in FIG. 2. The system 100 includes an operating system and software instructions executed by one or more computers and/or servers 202 and stored in memory 204, such as a persistent, updatable store. The software instructions may include software applications, programs, modules, and other constructs that, when executed by the computers/servers, cause the computers/servers to perform the various methods of the system 100, such as described in the flowcharts herein. The servers may, for example, host and support any webpages provided by the system 100. Various databases 206 may be incorporated into the system 100 to store organized information such as registered user data, including user profile information, identification of stocks owned, nature of stock ownership, associated brokers, topics of interest, voting cohort groups, user authentication and security data, voting decisions, voting items, and so forth. One or more databases 206 may store communication information and relevant interaction data for the various entities that operate with the system 100, including the investment brokers 104, asset managers 108, social media platforms 110, synthetic vote processor 112, stock lending agent 114, vote tally agent 116, and ballot agent 118. One or more databases 206 may store securities information, including issuing company, nature of ownership of the security (e.g., directly owned or indirectly owned), relevant EFT, relevant mutual fund, voting items, topics of interest related to voting items, social media data, and company-disseminated information gathered for the securities; voting cohort groups and their related topics of interest; and voting decisions collected from registered users and voting cohort groups. Communication interfaces 208, including secure communication interfaces, are provided to facilitate communication via one or more wired and wireless communication networks between the system computers and/or servers 202 of the system 100 and the other entities, including the registered users 102, investment brokers 104, asset managers 108, social media platforms 110, synthetic vote processor 112, stock lending agent 114, vote tally agent 116, and ballot agent 118. The system 100 facilitates social interaction among the registered users 102 to promote a more informed voting decision. The infrastructure for this social interaction is implemented with software processes and procedures described below.

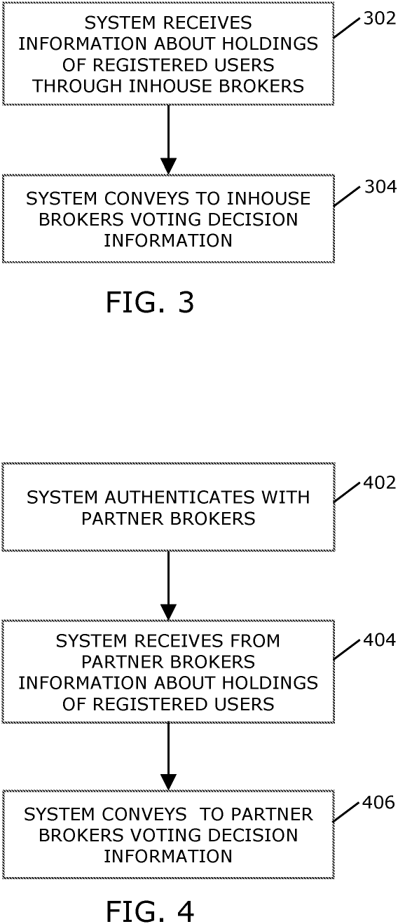

A flowchart illustrating a method for voting involving inhouse brokers is shown in FIG. 3. Individual investors may use the system 100 to making investments or transfer existing investments from other brokerage firms into the system 100. The system 100 acts as an inhouse broker 104 and holds the investment accounts for the registered users 102. Accurate information about the holdings of each registered user 102 is directly maintained by the system 100 in its inhouse broker 104 functionality. Integrating social interaction in the voting process may be a differentiating factor for the services offered by this inhouse broker 104. The system 100 receives 302 information about holding of registered users 102 through inhouse investment brokers 104. The system collects votes on voting items and conveys 304 voting decision information to the inhouse brokers 104. Because the inhouse brokers 104 are operated by the same entity that operates the system 100, additional security or authentication between the system 100 and the inhouse brokers 104 may not be needed.

A flowchart illustrating a method for voting involving partner brokers is shown in FIG. 4. The system 100 may operate in partnership with a third-party investment broker or partner broker 104, also referred to as a brokerage firm. An aspect of this partnership includes provision by the system 100 of a social interaction platform for the account holders at the partner brokers 104 to become registered users 102 of the system 100 where the registered users 102 having accounts with the partner brokers 104 may discuss and receive information about various corporate governance issues related to the companies in which the registered users 102 have invested. The system 100 may be closely integrated with the partner broker’s 104 infrastructure, receiving information such as registered users’ 102 holdings, and returning information such as voting decisions of registered users 102 to the partner broker 104. Integrating such social interaction in the voting process may be a differentiating factor for the services offered by the partner broker 104. The system 100 authenticates 402 with the partner brokers 104 before security information is communicated between the system 100 and the partner brokers 104. Authentication may include any verifiable authentication system, including, for example, two-factor authentication, as approved and appropriate to convey securities information. Communication channels are advantageously encrypted to enhance security of information transmission. The system 100 receives 402 information about holding of registered users 102 from partner investment brokers 104. The system collects votes on voting items and conveys 404 voting decision information to the partner brokers 104.

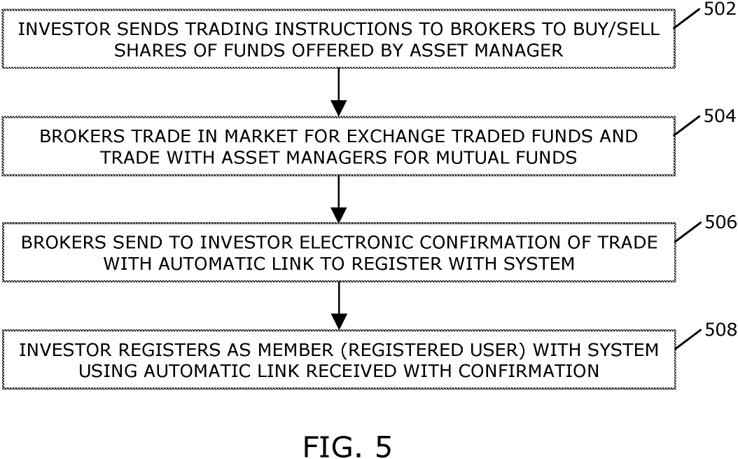

A flowchart illustrating a method for purchase of shares and registration of investors as members in an electronic voting system is shown in FIG. 5. An investor purchases an indirectly-owned security interest in a company by sending 502 trading instructions to an investment broker 104 to buy and/or sell shares such as mutual funds offered by an asset manager 108. The investor may also purchase a directly-owned security interest in a company by sending trading instructions to an investment broker 104 to buy and/or sell shares offered through the public market 106 for security interests. The investment broker 104 trades 504 in the public market 106 for directly owned security interests and trades with the asset managers 108 for mutual funds, ETFs, or other indirectly-owned security interests.

The investment broker 104 sends 506 electronic confirmation of all trades for directly and indirectly owned securities to the investor with an automatic link to the register with the system 100. Optionally, the investor may invest directly with the asset manager 108 instead of through an investment broker 104, in which case the asset manager 108 sends 506 electronic confirmation of all trades for funds purchased through the asset manager 108 to the investor with an automatic link to the register with the system 100. The investor becomes a member or registered user in the system 100 by using the automatic link to register 508 the ownership of the purchased securities of a company with the system 100. The automatic link verifies to the system 100 the purchases from the brokers 104 or asset managers 108 to facilitate registration of the investor with the system 100. Registering user ownership of securities of a company comprises at least one of authenticating the user via a link issued by the investment broker 104 that confirms purchase of securities in the company by the user, authenticating the user via a link issued by the asset manager 108 that confirms purchase, by the user, of a fund managed by the asset manager 108, and authenticating the user via a link issued by a verified account aggregation service, such as Yodlee, that confirms purchase of securities in the company by the user.

These links advantageously include unique data, that may be encrypted using known hashing methods, which data provide the system 100 with sufficient information to identify an investor’s investment account at a broker 104 or asset manager 108 that holds the investment accounts. This registration may only be needed after a first purchase by an investor with the broker 104 or asset manager 108. Through the registration process, the investor provides the system 100 with permission to receive information from the broker 104 or asset manager 108 about any trading in that investor’s account. This type of surveillance may, for example, be implemented using existing infrastructure such as Sungard’s Protegent Personal Trading Assistant, a commercial software product, or other similar surveillance systems, that may be modified to operate with the system 100.

The system 100 may operate in partnership with asset managers 108, for example, providers of ETFs. An aspect of this partnership includes provision by the system 100 of a social interaction platform for investors in funds managed by the asset managers 108 to become registered users 102 of the system 100 where the registered users 102 who are investors in the funds managed by the asset managers 108 may discuss and receive information about various corporate governance issues related to the companies in which the registered users 102 have invested through the fund managed by the asset manager 108. Through this interaction, the registered users 102 may determine and communicate to the asset manager 108 how the registered users 102 want the manager 108 to exercise the votes of the underlying or indirectly owned shares held by the manager 108 on behalf of the registered users 102.

The partnership between the system 100 and asset manager 108 facilitates creation of what is referred to as a social fund herein. A social fund includes, for example, a fund such as an ETF or mutual fund, offered by a partner asset manager 104 and supported by the system’s 100 social infrastructure functions as provided to registered users 102 of the system 100 as described herein. A hypothetical example of such a social fund might be called SPYESG, an ETF that tracks the performance of the SPX index (Standard and Poor’s index), and is similar to the currently available SPY ETF, with the additional benefit that buyers in the SYPESG ETF become registered users 102 of the system 100 and gain access to the system’s social interaction platform and through that interaction, the system 100 instructs the asset manager 108 offering this social fund how the registered users 102 want their shares to be voted on various corporate voting items. This interaction may result in a higher level of engagement among investors and allow customization of voting by the asset manager 108 to registered users’ 102 views of corporate governance and other ESG topics.

Providing a social interaction mechanism with the ability to express views on how to run the underlying companies via voting the shares may make an investment product more appealing to some investors. Investors may be informed that some investment products, such as social funds as described herein, offer a social interaction mechanism through advertisement by the asset manager 108 or the system 100 or system’s 100 operator.

Once the investor has registered with the system 100, the investor becomes a registered user 102 of the system 100. A registered user 102 may take full advantage of all provisions of the system 100 as described herein.Because the system 100 advantageously receives all information about registered users’ 102 trading through brokers 104 and asset managers 108, the system 100 has the information needed to calculate the direct and indirect holdings of the registered users’ 102 in each of the securities. The registered users’ 102 may use the social interaction feature of the system 100 to learn about voting items and vote shares for their investments. The system communicates the relevant voting decision to the brokers 104, asset managers 108, or other voting agents at appropriate times, for example, just before the AGM.

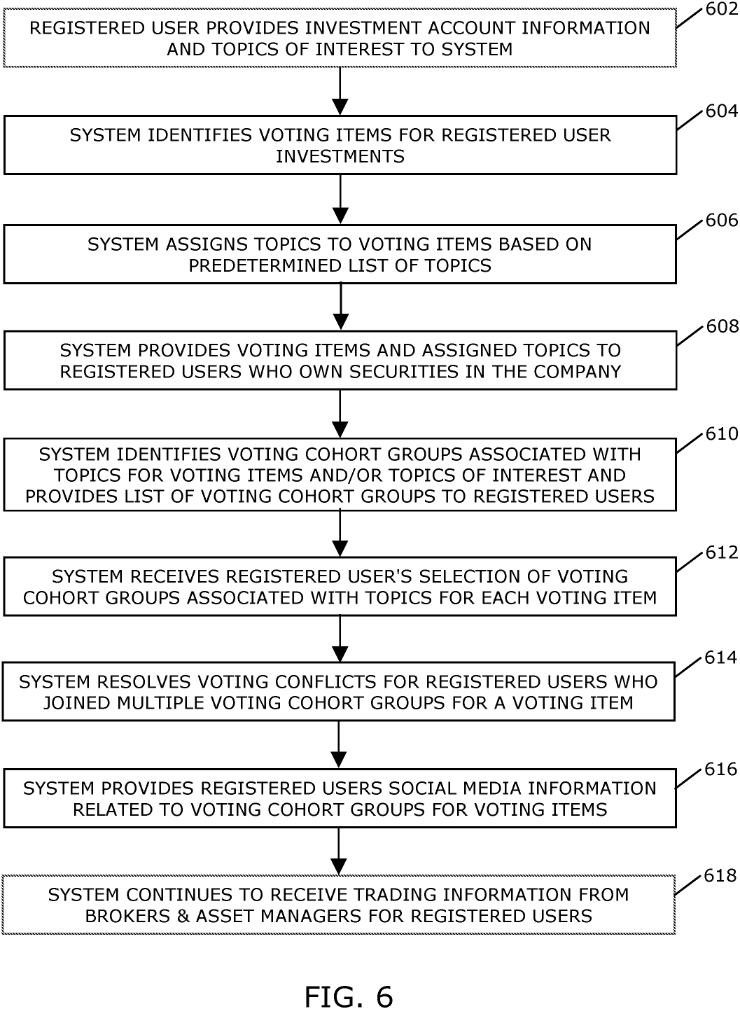

A flowchart illustrating a method for identifying topics of interest and voting cohort groups for voting items is shown in FIG. 6. Each registered user 102 provides 602 investment account information to the system 100 to link their investment accounts to the system 100 to enable the system 100 to access the registered user’s 102 investment accounts, for example, to permit the system to vote the shares of owned securities. The system may access accounts of registered users by at least one of (a) authenticating, with the investment broker 104 holding the securities of the company, over a public link by using registered user’s credentials, (b) authenticating, with the investment broker 104 holding the securities of the company, over a dedicated link, and (c) authenticating, with a third-party system used for surveillance of investment accounts, by using the registered user’s credentials. The registered users 102 may update their investment accounts with brokers 104 and/or asset managers 108 through a settings or profile stored in a database 206 of the system 100.

The system 100 may frequently pull the information related to each registered user’s 102 investment accounts to maintain an accurate representation of each registered user’s 102 holdings. This information pulling may be performed using existing data capture technologies from entities such as Yodlee or in the backend via a bilateral communication between the system 100 and investment accounts held by brokers 104 and/or asset managers 108. The system may implement multiple mechanisms to verify that linked accounts are actually owned by the registered user 102, including initial and subsequent attestations by the registered user 102 and verification via back-end linkage with external account sources such as the brokers 104 and asset managers 108.

Through the use of software or statistical techniques, the system 100 may identify breakage of linkage or otherwise abnormal changes in the holding of an external investment account. The breakage may occur due to a change in password, closure of an external account, moving investments to a new and not yet linked account, or other reasons. The system 100 encourages users to enter information needed to take an appropriate remedy to correct such breakage.

The registered users 102 also provide 602 topics of interest to the system 100, which topics advantageously pertain to one or more of the purchased securities and the companies that issued the securities. The system 100 receives and stores in a database identified topics of interest from the registered users 102.

For each of the registered users’ 102 investments in companies, the system 100 identifies 604 voting items for the investments associated with the relevant company. A voting item includes, for example, a question put to a shareholder’s vote by a company. Some voting items are similar across many companies and may reoccur, such as voting for individuals nominated to be on the company’s board of directors. Other voting items may be specific to a company or situation, such as policies related to the environment or labor forces based on the way the company conducts business. Identifying the voting items associated with the company includes parsing voting information obtained from at least one of a Securities and Exchange Commission filing, a website for the company, and other public notification sites for voting items. The system 100 captures, simplifies, and categorizes information related to voting items for easy access by a registered user 102.

The system 100 captures voting items associated with shares of a company. Given the highly regulated nature of managing public companies in most jurisdictions, the information for voting items that are put to vote at upcoming company meetings are generally publicly available via relevant regulatory bodies. For example, in the United States, this information is available from the Edgar system operated by the Securities and Exchange Commission (SEC). An example of a shareholder proposal is shown in Example 1 below.

Example 1

SHAREHOLDER PROPOSAL 1
Pay Equity
Whereas: Pay inequity persists across race and gender. Black workers’ hourly median earnings have fallen 3.6 percent since 2000, representing 75.6 percent of white wages. The median income for women working full time is 80 percent that of men. Intersecting race, African American women make 62 cents, Native women 60 cents, and Latina women 54 cents. At the current rate, women will not reach pay equity until 2059, African American women until 2130, and Latina women until 2224.
Citigroup estimates closing minority and gender wage gaps 20 years ago could have generated 12 trillion dollars in additional income and contributed 0.15 percent to United States GDP per year. PwC estimates closing the gender pay gap could boost Organization for Economic Cooperation and Development (OECD) countries’ economies by 2 trillion dollars annually.
Diversity is linked to superior stock performance and return on equity. Actively managing pay equity is associated with improved representation. Underrepresented minorities account for 14 percent of Company’s workforce and 9.4 percent of leadership. Women represent 28.6 percent of the workforce and 21.1 percent of leadership.
Pay gaps, literally defined as the median pay of minorities and women compared to the median pay of non- minorities and men, are considered the valid way of measuring gender pay inequity by the United States Census Bureau, Department of Labor, OECD, and International Labor Organization.
Best practice pay equity reporting consists of two parts:
1. unadjusted median pay gaps, assessing equal opportunity to high paying roles,
2. statistically adjusted gaps, assessing pay between minorities and non-minorities, men and women, performing similar roles.
Company reports parity for statistically adjusted gaps but ignores unadjusted median gaps, which address the structural bias women and underrepresented minorities face regarding job opportunity and pay, particularly when white men hold most higher paying jobs.
The Equal Employment and Opportunity Commission now mandates pay data reporting, across race and gender, as workforce diversity data alone is insufficient to assess pay inequity. The United Kingdom mandates disclosure of median gender pay gaps and is considering race and ethnicity reporting. Company reported a 10.3 percent median base pay gap and 37.5 percent bonus gap for U.K. employees.
Resolved: Shareholders request Company report on median pay gaps across race and gender, including associated policies.

The system 100 captures voting items by utilizing a software program that parses the relevant text segments from the associated regulatory filings, such as the above example in TABLE 1. The software program regularly monitors the relevant regulatory dataset and parses applicable filings once available. Such software programs may be developed using many packages and programming languages, such as the Beautiful Soap package of the Python programming language. The output of this program is a set of data files such as XML (Extendable Markup Language) files that represent each filing and each voting item within the filing. Such files are referred to as raw voting item files herein. The data capture system may produce one raw voting item file based on the content of each filing found through relevant regulatory sources. An example of a raw voting item file is shown in Example 2. An optional validation stage based on human review may be implemented to ascertain that the information captured via the automated process is accurate and complete.

### Example 2

<schedule14A>
<srcURL>https://www.sec.gov/Archives/edgar/data/789019/00011931252129
8757/d189481ddef14a.htm</srcURL>
<filingCompany>ABC Company </filingCompany>
<title>Notice of Annual Shareholders Meeting and Proxy Statement
2022</title>
<meetingDate>November 30, 2022 9:00 a.m. Pacific Time</meetingDate>
<internalDocumtnId>123123</internalDocumtnId>
... ## any other document information that may be useful
...<item id=“1”>
<topic>Pay Equity</topic>
<title>XYZ Capital and a co-filer have advised us that they intend to submit
the following proposal for consideration at the Annual Shareholders
Meeting</title>
<whereas>Pay inequity persists across race and gender. Black workers’
hourly median ... </whereas>
<resolved>Shareholders request ABC Company report on median pay gaps
across race and gender, including ...</resolved>
<boardRecommendation>AGAINST</boardRecommendation>
<boardRecommendationReason>The requested report is not necessary to
understand ABC Company’s commitments ...</boardRecommendationReason>
<additionalInformation>In our most recent Diversity & Inclusion Report,
...</additionalInformation>
</item>
<item id=“2”>
... ## information pertaining to the second item in this filing if it exists
</item>
... ## there will be one pair of <item> tag for each additional item in the
filing
</schedule14A>

Commercial data providers, such as Proxy Insight, extract voting item information to sell as a commercial dataset. The system 100 may partner or purchase the parsed data from such a third party. The system 100 may include software programs that transform the data produced by third party vendors into a set of data files similar to the raw voting item files described above.

The system 100 may also parse other data sources, for example, the relevant section of the investor sections of company websites or news providers, such as Thompson Reuters, to complement the raw voting item file. Each additional piece of information extracted from these complementary sources may be added as an extra tag in the relevant section of the raw voting item file XML file. Raw data files may be updated as the parsing software finds new information pertaining to a filing or a particular item from these additional sources.

The system 100 may utilize both inhouse data extraction capabilities as well as obtaining this information from third-party vendors and include software programs that combine the information based on a logic implemented in software and enhanced by human verification, with the goal of producing accurate and comprehensive raw voting item files. After the raw voting item files are produced, the system 100 includes a method to enhance the raw data. The output files of this method are referred to herein as enhanced voting item files.

The system 100 may simplify the voting item information. Information the companies provide varies in form and format. Such information is written with legal terms to comply with the regulated environment of managing public companies. The system 100 includes processes that may be any combination of automated, using Machine Learning methods with human oversight, and human performed to simplify the captured information for easier understandable by the registered users. Example 3 is an example of the type of information as modified via the simplification process.

### Example 3

<schedule14A>
... ## information from previous example of omitted to save space
...
<processStage>Item simplification</processStage>
<processStageSource>Item Simplified AI algo, version
1.0</processStageSource>
<humanDataValidation>Yes</humanDataValidation>
<humanDataValidator>John Doe</humanDataValidator>
... ## any other document information that may be useful
<item id=“1”>
<topic>Pay Equity</topic>
... ## information from previous example of omitted to save space
<simplifiedResolve>Report on Race & Gender Median Pay
Gaps</simplifiedResolve>
<proponent>XYZ Capital Social </proponent>
<proponentType>Socially Responsible Investing Funds </proponentType>
</item>
<item id=“2”>
... ## information pertaining to the second item in this filing if it exists
...
</item>
... ## there will be one pair of <item> tag for each additional item in the
filing
...
</schedule14A>

The system 100 assigns 606 one or more topics to each voting item based on a predetermined list or hierarchy of topics. A topic may be classified as a topic and subtopic. For example, a vote dealing with carbon emission may be categorized as environmental/global warming, a vote dealing with disposing of waste into water resources may be classified as environmental/water safety, and a vote dealing with usage of non-recyclable plastic in the supply chain may be classified as environmental/waste. Topics and/or subtopics used within the system 100 may represent topics for each voting item as well as topics of interest for registered users 102. This hierarchy is referred to herein as a Corporate Governance Topic Hierarchy (CGTH). The hierarchy may be uniquely derived or developed for the system 100 or licensed from a third party.

A software program may use Natural Language Processing (NLP) techniques to process a raw voting item file to identify the topic. Alternatively, software may be developed to streamline the process of human review of the voting items and assign topics. A combination may be utilized, where NLP software produces an initial topic that a human verifies. Each additional piece of information, for example, a voting item topic, may be easily added as an extra item in the XML schema of the voting item file. Example 4 shows an example of of an implementation of such a categorization.

### Example 4

<schedule14A>
... ## information from previous example of omitted to save space
...
...<item id=“1”>
... ## information from previous example of omitted to save space
<proposalTypeRoot>Social Policy</proposalTypeRoot>
<proposalTypeSpecific>Gender/Racial Equality</proposalTypeSpecific>
<proposalTypeLeaf>Pay Gaps</proposalTypeLeaf>
</item>
<item id=“2”>
... ## information pertaining to the second item in this filing if it exists
...
</item>
... ## there will be one pair of <item> tag for each additional item in the
filing
</schedule14A>

All captured voting items are categorized with topics using a predetermined hierarchy such as the CGTH or other appropriate hierarchy. An example of a section of the CGTH is shown in Example 5. Additional levels and leaves may be added as appropriate.

### Example 5

<CorporateGovernance>
Board Diversity
Chairman Independence
Corporate Purpose
...
<ExecutiveCompensation>
Equity Comp Rules
Exec Pay Comparison
Exec Retirement Benefits
...
<SocialPolicy>
Climate Risk
Environmental
Waste Management
Water Safety
...
Gender/Racial Equality
Pay Gap
Management Progression
...
...

Assigning the topic to the voting item may include applying an artificial intelligence algorithm to identify at least one topic for the voting item from topics in the predetermined topic hierarchy and voting information for the voting item.

Social interaction among registered users 102 may be initiated by their interest in a topic assigned to a voting item. When registering with the system 100, or at any future time by going to the settings section of the system’s website or mobile app or by prompt from the system 100, a registered user 102 may specify or change the topics of interest to the registered user 102. This information is captured in a database 206 within the system 100. An example of representation of information for a registered user 102, including the user’s topic of interest list, is shown in Example 6.

### Example 6

<memberInformation>
<memberName>John Doe</memberName>
<memberId>123123</memberId>
<memberInterest id=“1”>
<proposalTypeRoot>Social Policy</proposalTypeRoot>
<proposalTypeSpecific>Gender/Racial Equality</proposalTypeSpecific>
<proposalTypeLeaf>Pay Gaps</proposalTypeLeaf>
</memberInterest>
<memberInterest id=“2”>
<proposalTypeRoot>Environmental Policy</proposalTypeRoot>
<proposalTypeSpecific>Global Warming</proposalTypeSpecific>
<proposalTypeLeaf>Carbon Emission</proposalTypeLeaf>
</memberInterest>
<memberInterest id=“3”>
...
...
</memberInterest>
</memberInformation>

Identifying topics of interest may include, based at least on the assigned topic, generating an interest score for the voting item for registered users 102 who own securities in the company, and based on the interest scores, providing the voting item and the assigned topic to the registered users 102 who own securities in the company. Generating the interest score for the voting item includes applying an algorithm that produces the interest score for the voting item for each registered user by combining data from at least one of: the registered user’s holdings, topics of interest identified by the registered user, topics identified for the voting item, registered user’s prior interactions on the system, previous discussions on the social media platform, amount of attention related to the voting item such as a number of followers on a social media platform related to the topic, voting date for the voting item, related information from public sources, information published by the company, and so forth.

When a new voting item is captured as described above, a method implemented in software compares the newly captured voting item with the profile of all registered users 102. The method outputs the interest score as a numerical value, for example, between 0 and 1, that represents how likely the newly captured voting item may be of interest to a given registered user 102. Registered users 102 may only be presented with voting items related to companies in which their holding exceeds a minimum threshold. This interest score may also be referred to as an Item-Member Match Score (IMMS) for short.

The topic of the voting item is an input in the algorithm producing the IMMS. Other inputs, such as size of that registered user’s 102 investment in the underlying company, how controversial that voting item seems to be based on analysis of voting items feeds, also referred to as news feeds, Artificial Intelligence (AI) algorithms applied to historical voting patterns, current discussion on the system 100, or the time is left until the company shareholders meeting may all be possible inputs to the algorithm that produces the IMMS.

The IMMS may dynamically change based on discussions taking place in the system 100. For example, when a voting item receives attention, via entry of a comment, for example, by someone a particular registered user 102 follows, that voting item receives a higher rank or weighting in the IMMS algorithm. When a voting item begins to receive a lot of attention by many registered users 102, in particular by influential registered users 102, for example, by those with a large following, that voting item is also assigned a higher IMMS. The system 100 may have a concept of trending voting items, such as voting items that are discussed widely on the system 100 or other relevant websites.

A higher IMMS value may indicate a higher likelihood that the particular voting item may be of interest to the registered user 102. An example of an output of the IMMS algorithm is shown in Example 7.

### Example 7

<IMMS_Algorithm_Output>
<memberId>123123</memberId>
<IMMS_Algorithm>IMMS AI NLP, version 1.0</IMMS_Algorithm>
<Production_time>April 29, 2022, 2:05PM ET</Production_time>
... ## any other document information that may be useful
...
<IMMS_Output_Detail>
<internalDocumtnId>345345</internalDocumtnId>
<itemId>1</itemId>
<IMMS_Score>0</IMMS_Score> # Believed to be totally irrelevant for this
person
</IMMS_Output_Detail >
<IMMS_Output_Detail>
<internalDocumtnId>345345</internalDocumtnId>
<itemId>2</itemId>
<IMMS_Score>0.9</IMMS_Score>
</IMMS_Output_Detail >
<IMMS_Output_Detail>
<internalDocumtnId>67654</internalDocumtnId>
<itemId>1</itemId>
<IMMS_Score>1.0</IMMS_Score> # Believed to be very relevant for this
person
</IMMS_Output_Detail>
...
...
</IMMS_Algorithm_Output>

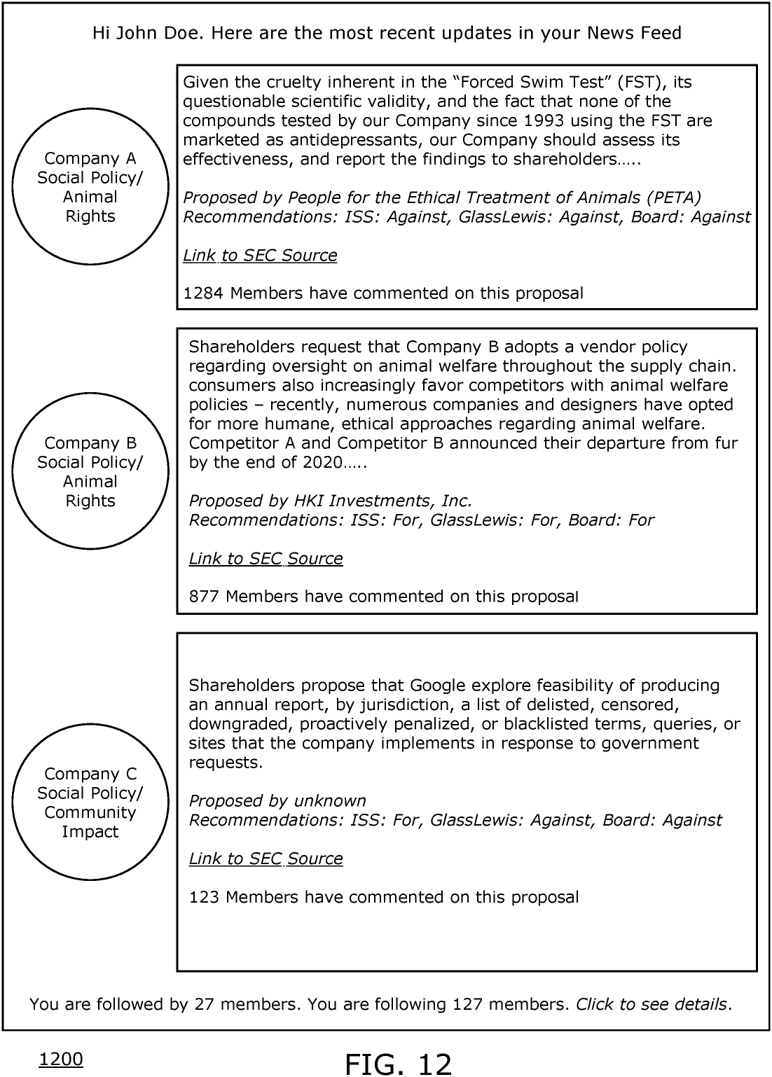

Each time a registered user 102 logs into the system’s 100 website or mobile app, the registered user 102 is shown a list of voting items based on the IMMS in the “news feeds” section of the system’s 100 website or mobile app. A diagram illustrating a layout for a news feed for voting items presented to a registered user on a display is shown in FIG. 12.

Voting items may be ranked based on their IMMS. Because voting items with a higher IMMS have a higher likelihood of being of interest to a particular registered user 102, such voting items may be presented closer to the top of the list of voting items presented to the registered user 102.

The system 100 keeps track of which voting items have been presented to each registered user 102 to avoid showing the same voting items repeatedly unless the registered user 102 desires the repetition. The IMMS score is advantageously recalculated each time a member logs into the system 100. The IMMS may change due to social interaction on the system 100, such as when other registered users 102 comment on a voting item or external data such as news wires, third party social media websites, the company website, and so forth. If the IMMS score has changed significantly since the last time the registered user 102 logged into the system 100, the voting item may be shown again at a high position in the voting items feed. The most relevant voting items are advantageously presented to each registered user 102 in their voting items feed.

The system 100 provides 608 the voting item and its assigned topic(s) to the registered users 102 who own securities of the company associated with the voting item. The system 100 presents this information, for example, via the system’s 100 website and mobile app. Alternatively, such information may be sent to the registered users 102 via email, short message service, or text, which a registered user 102 may subscribe to based on their investments. For example, a registered user 102 interested in the policy of companies in dealing with waste may search the system’s 100 website and mobile app for the type of questions that were put to vote dealing with that topic waste, read the context around those questions, view historical voting results, and other related information posted on the system’s 100 website.

The system 100 identifies 610 voting cohort groups that are related to the topics of interest for the registered user 102 and/or topics assigned to the voting items and presents or provides a list of relevant voting cohort groups to the registered user 102. A voting cohort group may include, for example, an organization or club of like-minded individuals who may be organized around one or more topics of interest. The registered user 102 informs the system 100 about voting cohort groups the registered user 102 decides to join. Upon joining a voting cohort group, the registered user 102 agrees to cast their votes on voting items according to a majority decision or majority-rule vote of the voting cohort group for any voting item related to the voting cohort group. Voting items may be related to a voting cohort group, for example, by topic of interest. A voting cohort may recruit members to achieve the cohort’s objectives, including, for example, promoting topics of interest related to securities and the issuing companies. The system 100 receives 612 the registered user’s selection of voting cohort groups associated with topics of interest. Alternatively or additionally, the system 100 may receive 612 the registered user’s selection of voting cohort groups when a topic is assigned to a voting item. A registered user 102 may join or unjoin (revoke membership in) a voting cohort group at any time, including joining or unjoining temporarily. Joining voting cohort groups may reduce the time burden for entering voting decisions on voting items. A registered user 102 may create a voting cohort group associated with one or more topics, such as the topics of the CGTH or other topic hierarchy. Alternatively, a registered user 102 may select voting cohort groups based on topics of interest to the registered user 102, rather than topics assigned to a voting item.

Voting cohort groups may have other attributes. For example, each voting cohort group may have one or more registered users 102 who act as moderators for the voting cohort group. Moderators function as guardians of the voting cohort group. For example, a moderator may tag content from a discussion that is believed to be misinformation or unduly offensive. Each voting cohort group has a set of members who are registered users 102 who have elected to be part of this particular voting cohort group and cast the voting power of their investments with the majority decision of the members of this voting cohort group. Within the system 100, each voting cohort group is represented by a set of attributes stored in a databases 2016 in an XML file for each voting cohort group. An example of voting cohort group membership information for one registered user 102 is shown in Example 8.

### Example 8

<VotingCohortDefinition>
<name>American for Ethetical Treatment of Animals</name>
<leadModerator>John Doe</leadModerator>
<otherModerators>Sus Doe, Rob Low, and Tom Vow</otherModerators>
... ## any other document information that may be useful
<cgthTopicList id=1>Social Policy/Animal Rights</cgthTopicList>
<cgthTopicList id=2>Environmental/Natural Habitat</cgthTopicList>
... ## potentially other topics
<memberIds>123,234,45,47,.....</memberIds>
</VotingCohortDefinition>

By joining a voting cohort group, registered users 102 agree to cast their votes with the majority decision of members of that voting cohort group for any voting items that fall under the list of topics covered by that voting cohort group. A registered user 102 may join multiple voting cohort groups. The list of CGTHs covered by a voting cohort group may advantageously be non-overlapping or disjoint. The system 100 checks for any conflict at the time registered user 102 selects or updates their voting cohort group membership and prompt the user to take corrective action or advantageously when the conflict arises over a particular voting item.

During the period leading to the annual meeting of companies or other situations where a shareholder vote is held, a discussion may occur among registered users 102 on the system, culminating with some registered users 102 casting votes. By joining a voting cohort group, registered users 102 agree that for each voting item, the registered users 102 will cast their vote according to the voting decision of a majority of members of the cohort for voting items related to topics associated with the voting cohort group. The majority decision or majority rule may be determined by an algorithm such as a vote imputation algorithm as described below. The system 100 automatically casts the registered user’s 102 vote according to the voting decision of a majority of members of the voting cohort group joined by the registered user 102, for example, when the registered user 102 has not otherwise voted.

An example of a vote imputation algorithm includes the following method. Prior to the voting date for a voting item for company A and related to topic T, the system 100 determines a cut-off time for imputing a vote for each voting cohort associated with topic T. At the cut-off time, the system 100 identifies whether the registered users 102 who cast a vote for the voting item with the system 100 belong to a voting cohort group that covers topic T. All votes cast within each voting cohort group that covers topic T are aggregated as determined by the holdings of the registered users 102 casting that vote in the security of company A, across both direct stock holding and indirect holding via ETFs. For example, all registered users 102 who did not cast a vote on the voting item, identifying whether the non-voting registered users 102 belong to a voting cohort group that covers topic T. When any registered users 102 are members of a voting cohort group, their votes are assigned to the vote cast by the majority of the registered users 102 for the associated voting cohort group. See Example 9 for an example of the system 100 applying a vote imputation algorithm.

### Example 9

100 registered users own 5000 shares of stock in company A.
50 registered users belong to voting cohort group X and own 3000 shares
35 registered users belong to voting cohort group Y and own 1000 shares
15 registered users belong to no voting cohort group and own 1000 shares
60 registered users voted yes for the voting item
   18 unaffiliated registered users voted yes and own 800 shares
   40 registered users, owning 800 shares, voted yes from voting cohort group X
   2 registered users, owning 50 shares, voted yes from voting cohort group Y
   10 yes votes are imputed to non-voting members of voting cohort group X
30 registered users voted no for the voting item
   5 unaffiliated registered users voted no and own 100 shares
   5 registered users, owning 200 shares, voted no from voting cohort group X
   20 registered users, owning 800 shares, voted no from voting cohort group Y
   15 no votes are imputed to non-voting members of voting cohort group Y
10 unaffiliated registered users did not vote and own 100 shares

As a result of the voting shown in Example 9, the system 100 conveys 3000 yes votes for voting cohort group X plus 800 votes for unaffiliated (no voting cohort group joined by) registered users for a total of 3800 yes votes and conveys 1000 no votes for voting cohort group Y plus 100 votes for unaffiliated registered users for a total of 1100 no votes according to the vote imputation algorithm described above. The system 100 conveys the votes according to the nature of ownership, such as direct or indirect ownership. For example, votes for directly owned shares may be conveyed through the brokers 104 and votes for indirectly owned shares may be conveyed through the asset manager 108.

A registered user’s 102 voting power may refer to total holdings across both direct holdings and indirect holdings for the registered user 102 in a company. For the purpose of weight associated with each member in a voting cohort group aggregation and imputation, a registered user’s 102 direct holdings and indirect holdings are added together. A registered user’s 102 direct holding information and ETF holding information are merged to arrive at the registered user’s 102 voting power as shown in the example XML file information below.

Direct Holding Information
<holdingList>
<memberId>123123</memberId>
... ## any other information that may be useful
<holding>
<ticker> IBM </ticker>
<quantity> 5000 </quantity>
</holding>
<holding>
<ticker> ORCL </ticker>
<quantity> 1000 </quantity>
</holding>
<holding>
<ticker> ETF1 </ticker>
<quantity> 1000 </quantity>
</holding>
.... # other holdings
....
</holdingList>

ETF Holding Information
<etfInformation>
<etfTicker> ETF1 </etfTicker>
<etfManager> Fidelity </etfManager>
... ## any other information that may be useful
<holding>
<ticker> IBM </ticker>
<quantity> 0.5 </quantity>
</holding>
<holding>
<ticker> ORCL </ticker>
<quantity> 0.25 </quantity>
</holding>
</etfComposition>

Registered user’s 102 calculated voting power
<votingPower>
<memberId>123123</memberId>
<holding>
<ticker> IBM </ticker>
<power> 5500 </power>
<powerDecomposition>
<powerSource> Direct Holding </powerSource>
<quantity> 5000 </quantity>
</powerDecomposition>
<powerDecomposition>
<powerSource> ETF1 </powerSource>
<quantity> 500 </quantity>
</powerDecomposition>
</holding>
<holding>
<ticker> ORCL </ticker>
<power> 1250 </power>
<powerDecomposition>
<powerSource> Direct Holding </powerSource>
<quantity> 1000 </quantity>
</powerDecomposition>
<powerDecomposition>
<powerSource> ETF1 </powerSource>
<quantity> 250 </quantity>
</powerDecomposition>
</holding>
</votingPower>

A voting conflict may arise when multiple topics apply to a voting item and a registered user has joined a different voting cohort group for each different topic. For example, a voting item may link a CEO’s pay package with a goal to reduce the company’s carbon footprint. Because each share is entitled to only one vote, a voting conflict arises when a registered user 102 has joined multiple voting cohort groups that are associated with the same voting item. The system 100 resolves 614 voting conflicts for registered users 102 who have joined multiple voting cohort groups associated with a single voting item. For example, conflicts may be resolved by reducing or limiting the number of voting cohort groups for a single registered user 102 to one per voting item or requiring the user to manually vote on the voting item. Conflicts may be resolved by any of the following: (a) sending a message to the registered user 102 that the registered user has joined multiple voting cohort groups for a single voting item and providing the registered user 102 with an option to select only one voting cohort group for a particular voting item; (b) sending a message to the registered user 102 that the registered user has joined multiple voting cohort groups for a single voting item and identifying a default voting cohort group for a particular voting item that is one of the joined multiple voting cohort groups, which default voting cohort group may be the first voting cohort group joined by the registered user 102, the voting cohort group with the highest interest score for the registered user 102, or the voting cohort group most closely associated with the voting item; (c) limiting each voting item to a single topic, for example, based on a set of best practices; and (d) requiring the register user 102 to manually vote for the voting item.

The system 100 obtains and provides 616 to registered users 102 social media information related to voting cohort groups for voting items. The system 100 includes a website and mobile app that may be utilized by registered users 102 to access information related to their investments, including, for example, voting items and information related to the topics of interest, voting cohort groups, and companies issuing securities for their investments.

The system 100 continues to receive 618 trading information from investment brokers 104 and asset managers 108 for registered users 102 as the trading information becomes available. The system 100 adjusts the methods and processes according to the new trading information, including addressing issues related to securities not previously held by registered users 102, updating databases 206, adjusting voting mechanisms, addressing any new voting items, and so forth.

Registered users 102 may use the news feed or voting items feed as a launching point to interact with other registered users 102, view or write comments, follow other registered users 102, and socially interact with other registered users 102.

Registered users 102 have an opportunity to vote on each voting item in their voting items feed. As the voting time for a voting item approaches, for example, the AGM for one or more companies, the IMMS may start producing higher values for voting items related to those companies. As a result, more registered users 102 may vote on their topics of interest, including the most relevant or controversial topics, which may increase shareholder participation in a meaningful way. The system 100 may send notifications to the system’s 100 mobile app, which may be installed on the registered users’ 102 mobile devices, to inform the registered users 102 about upcoming or impending votes.

The system 100 may operate with existing proxy advisors, such as Glass Lewis or Institutional Shareholder Services (ISS), to bring in their recommendations to the system. These recommendations may be shown next to each voting item to facilitate the voting process, such as shown in FIG. 12.

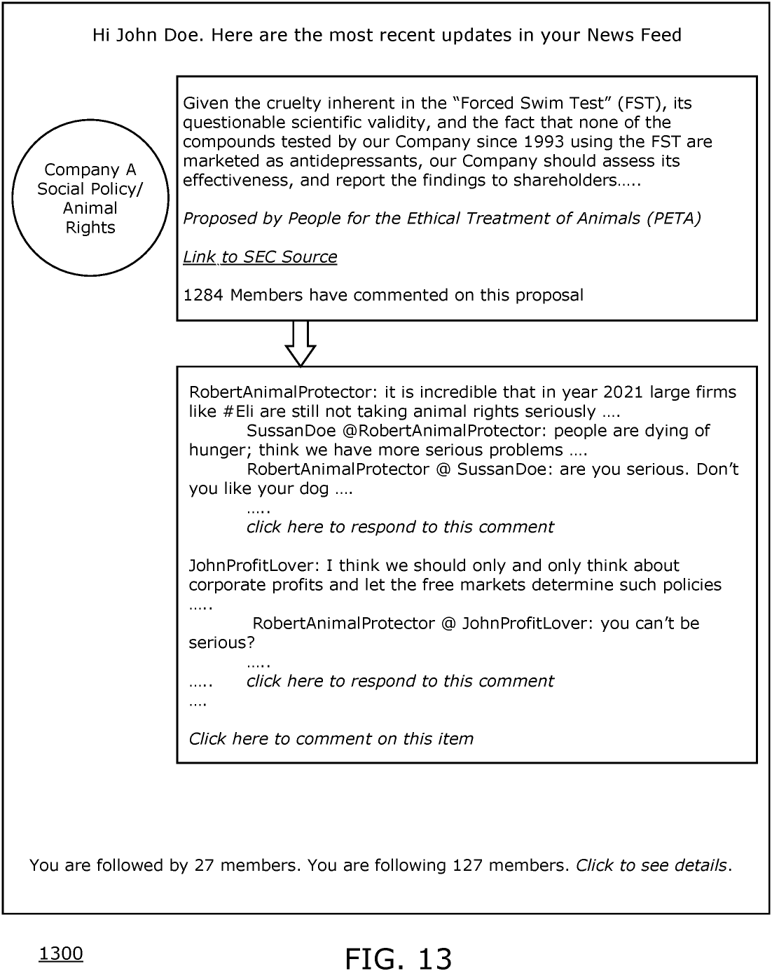

The system 100 provides registered users 102 with an opportunity to comment on each topic, which commentary is visible to all other registered users 102 on their voting items feed. In addition, registered users 102 may also comment on each other’s comments, resulting in a discussion and social interaction among registered users 102. A diagram illustrating a layout for social interactions related to a voting item and presented to a registered user on a display is shown in FIG. 13.

Optionally, the system 100 may provide the companies, for which registered users 102 own shares, with the ability to participate in the system 100. For example, the system 100 may provide the companies with access to a platform 110 incorporating a website for comments or discussions related to their company, including a dedicated place for posting information the companies are interested in sharing, such as information related to voting items or topics of interest. The system 100 may provide registered users who joined a voting cohort group with information and/or functionality facilitating interaction via a social media platform associated with the joined voting cohort group. The social media platform 110 may be provided as part of the system 100 or may be operated by a third party in cooperation with the system 100. The social media platform 110 may operate in conjunction with other third-party social media platforms that provide information, services, or a place for relevant discussions to be posted. The social media platform 110 may provide a place for registered users 102 to interact with each other and the companies in which the registered users 102 have invested in order to pursue their topics of interest including the voting cohort groups that the registered users 102 have joined. The system 100 may prioritize interactions on the social media platform by applying the interest score as described above.

Voting items are generally submitted to the company by their investors. Depending on the jurisdiction, the rules and processes concerning submission of voting items may be different. In one embodiment, registered users 102 may interact with each other to suggest and vote on voting items that the registered users 102 want to propose to the company as one of a list of voting items for the next AGM. In one embodiment, the system 100 may sponsor such voting items as follows:
1. Any registered user 102 proposes a voting item to be sponsored by the system 100 for the following AGM.
2. Other registered users 102 may view and comment on the proposed voting item. A period of time for such interaction is provided, which period is determined to allow for time for the proposed voting item to be placed on the agenda for the following AGM.
3. At the end of the period of time for interaction, the system facilitates a vote by the registered users 102 on the proposed voting item on the system 100.
4. The system collects and tallies votes on the proposed voting item, and may optionally impute votes to the registered users 102 according to voting cohort group membership.
5. The system 100 sponsors all proposed voting items that meet a specific voting threshold. Sponsoring by the system includes working with lawyers, the SEC, and the company to cause the proposed voting item to be on the agenda for the following AGM.

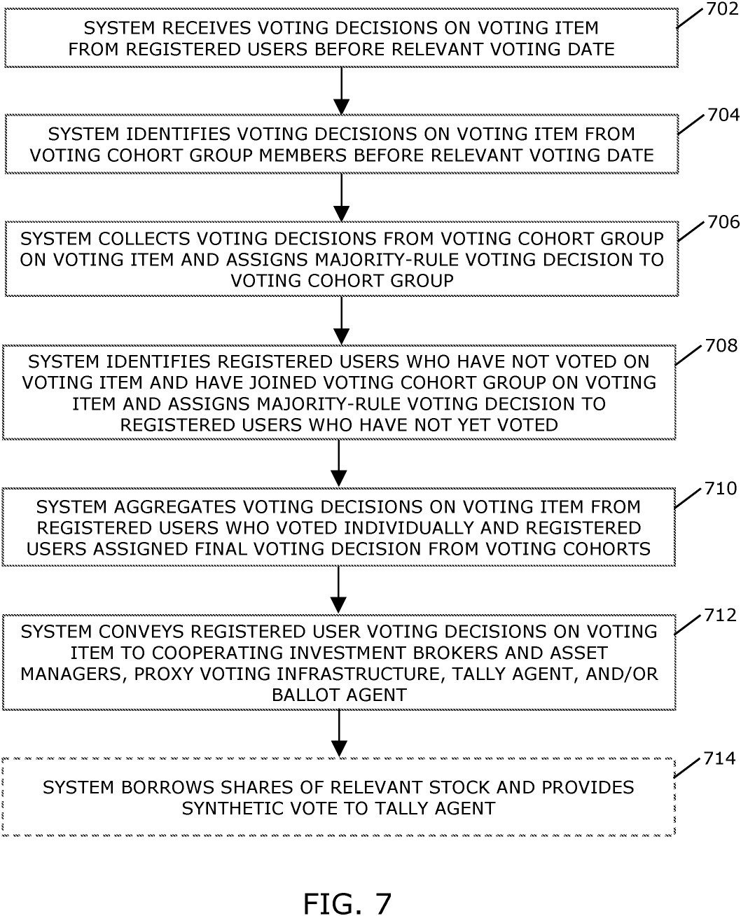

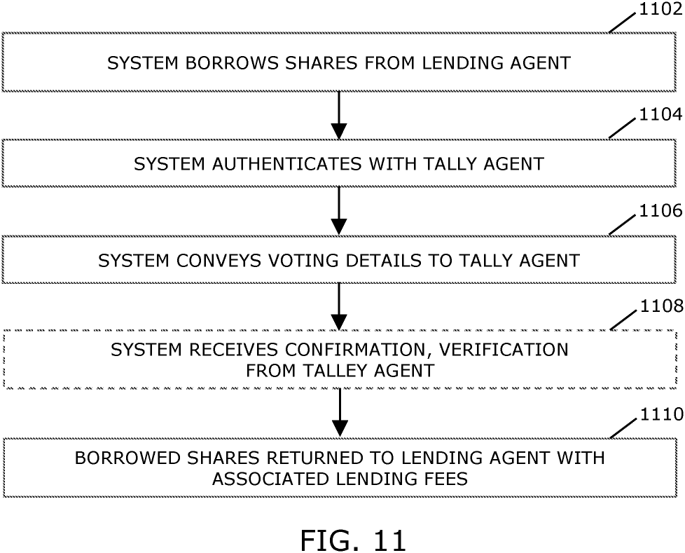

A flowchart illustrating a method for obtaining and determining voting decisions for a voting item is shown in FIG. 7. The system 100 receives 702 voting decisions, also referred to as votes, related to each voting item from the registered users 102 before the relevant voting date for the voting item. The system 100 advantageously provides an electronic mechanism for the registered user 102 to provide their voting decision to the system 100 to facilitate vote aggregation by the system 100. The system 100 identifies 704 voting decisions on each voting item from members of the voting cohort group before the relevant voting date for the voting item. The system 100 collects or aggregates 706 voting decisions on each voting item from each voting cohort group and assigns a majority-rule voting decision to each voting cohort group. The system 100 identifies 708 registered users 102 who have not yet voted on the voting item and have joined the voting cohort group on the voting item and assigns or imputes the majority-rule voting decision to these registered users 102 who have not yet voted. The system 100 thus aggregates votes received from the registered users who joined each voting cohort group and determines a majority-rule vote for all shares of the company for all registered users who joined the respective voting cohort group. The system 100 aggregates 710 voting decisions on the voting item from registered users 102 who voted individually and registered users 102 assigned a final or majority-rule voting decision from voting cohort groups. The system conveys the majority-rule vote to the company. For example, the system 100 conveys 712 the aggregated voting decisions on the voting item from registered users 102 to cooperating brokers 104 and asset managers 108, a proxy voting infrastructure of the company that issued the security for the voting item, a tally agent 116, a ballot agent 118, and/or any vote provision entity that provides votes to the company. Optionally, the system 100 may borrow 714 shares from a lending agent 114 and provide the resulting synthetic vote to a tally agent, such as described in more detail with respect to FIG. 11.

The system may identify the nature of ownership of the securities in the company and convey the voting decisions, such as the majority-rule votes and unaffiliated votes, to the company according to the nature of ownership. The nature of ownership may be, for example, direct ownership, indirect ownership, and so forth. The voting decisions may be conveyed via at least one of a proxy infrastructure, a ballot agent, a tally agent, an asset manager for an exchange traded fund or a fund holding the securities in the company, and a direct mechanism to the company.

When the registered user 102 directly holds a security, that registered user 102 has the right to register the registered user’s 102 vote for that security at the relevant company event, typically the Annual General Meeting (AGM). This voting may take place via a number of methods. In one approach, the system 100 may be connected to the existing proxy voting infrastructure to allow for automatic casting of the registered user’s 102 vote. This voting is typically performed by conveying the vote information to the tally agent 116, an entity hired by the company prior to their AGM to aggregate their shareholder votes. Broadridge is one example of a tally agent 116 in the United States.

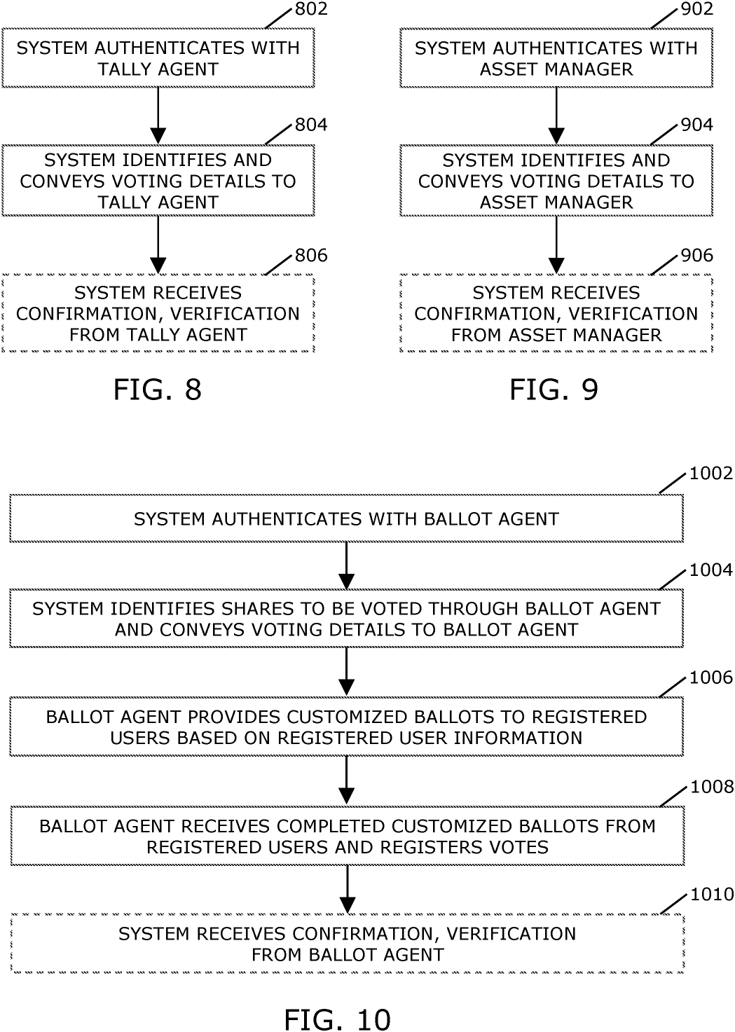

A flowchart illustrating a method for conveying voting information to a tally agent is shown in FIG. 8. The system 100 authenticates 802 with the tally agent 116 to provide a secure communication channel between the system 100 and the tally agent 116. The system 100 identifies 804 the number of shares directly owned by the registered users 102 and conveys 804 that number of votes to the tally agent 116 that registers the votes appropriately with the company that issued the shares, for example, at the AGM. The system 100 optionally receives 806 from the tally agent 116 a confirmation and verification of votes received by the tally agent 116 from the system 100 and provided to the company.

When the registered user 102 indirectly holds a security, for example, as part of an investment in an ETF or mutual fund, the voting information must be transmitted to the asset manager 108 of the relevant fund. Some large asset managers, for example Blackrock, are in the process of creating an infrastructure to allow large investors in their funds to vote their shares. Such a method of conveying an investor’s voting decisions for indirect holdings to an asset manager through a voting infrastructure may be referred to as pass-through voting. When the asset manager 108 of the fund provides an infrastructure for pass-through voting, the system 100 utilizes that infrastructure to convey the aggregated voting decisions to the asset manager 108 for indirectly held shares owned by the registered users 102. A flowchart illustrating a method for conveying voting information to a asset manager is shown in FIG. 9. The system 100 authenticates 902 with the asset manager 108 to provide a secure communication channel between the system 100 and the asset manager 108. The system 100 identifies 904 the number of shares indirectly owned by the registered users 102 through the asset manager 108 and conveys 904 that number of votes to the asset manager 108 that registers the votes appropriately with the company that issued the shares, for example, at the AGM. The system 100 optionally receives 906 from the asset manager 108 a confirmation and verification of votes received by the asset manager 108 from the system 100 and provided to the company.

In some situations and in some jurisdictions, automatically registering a vote with the tally agent 116 may not be legally permitted. Alternatively, the operator of the system 100 may work with ballot providers in a proxy voting infrastructure, to facilitate the system 100 conveying information to a ballet agent 118 such that the ballot agent 118 provides an electronic ballot to a registered user 102. The registered user 102 verifies the vote by clicking on the ballot. Broadridge is one example of a ballot agent 118 in the United States.

A flowchart illustrating a method for conveying voting information to a ballot agent is shown in FIG. 10. The system 100 authenticates 1002 with the ballot agent 118 to provide a secure communication channel between the system 100 and the ballot agent 118. The system 100 identifies 1004 shares of securities owned by the registered users 102, which shares cannot be voted automatically through the tally agent 116, for which share votes need to be registered through the ballot agent 118. The system 100 conveys 1004 voting details for the registered users 102 associated with the identified shares to the ballot agent 118. The ballot agent 118 provides customized ballots to these registered users 102 based on the voting details for the registered users 102 as provided by the system 100 to the ballot agent 118. The ballot agent 118 receives 1008 the completed customized ballots from the registered users 102 and registers the votes appropriately with the company that issued the shares, for example, at the AGM. The system 100 optionally receives 1010 from the ballot agent 118 a confirmation and verification of votes received by the ballot agent 118 from the system 100 and provided to the company.

The system 100 may cast votes by borrowing the required shares in the stock lending market. In most jurisdictions, the entity who borrows the share on the record date is considered the beneficial owner and is entitled to vote those shares. The cost associated with stock borrowing may be passed to the registered users 102 or may be subsidized by the operator of the system 100. This method of via borrowing stock to vote may be referred to as a synthetic vote. The system 100 may utilize synthetic voting when voting such as electronic voting is not otherwise possible through an asset manager 108, vote tally agent 116, or ballot agent 118. A flowchart illustrating a method for borrowing shares of a security and conveying voting information for the security is shown in FIG. 11. The system 100 borrows 1102 shares from a lending agent 114. The system 100 authenticates 1104 with the tally agent 116 to provide a secure communication channel between the system 100 and the tally agent 116. The system 100 conveys voting details for the borrowed shares to the tally agent 116 that registers the votes appropriately with the company that issued the shares, for example, at the AGM. The system 100 optionally receives 1108 from the tally agent 116 a confirmation and verification of votes received by the tally agent 116 from the system 100 and provided to the company. The system 100 returns 1110 the borrowed shares to the lending agent 114 with any associated lending fees.

The system 100 advantageously provides registered users 102 with: a mechanism to view voting items for their holding that fall under their topics of interest; a mechanism to comment on voting items; a mechanism to view comments made by other registered users 102; a mechanism to respond to comments made by other registered users 102; a mechanism to follow other registered users 102; and a mechanism to follow companies. The system 100 advantageous provides companies with: a mechanism to provide additional information related to their voting items, a mechanism to respond to registered user’s 102 comments on voting items related to that company, and a mechanism to have followers.

The system 100 may enter into an agreement or partnership with an asset manager to issue a specialized investment fund. The partnership requires the asset manager to vote on voting items for the security according to voting instructions issued by the system 100 once the system 100 conveys the voting instructions to the asset manager. The system 100 may register, as a registered user in the system 100, an investor in the specialized investment fund upon use of a weblink received by the investor from an investment broker 104 in response to purchase of the specialized investment fund by the investor from the investment broker 104. The system receives, from the registered user, credentials for the registered user’s investment account with the investment broker 104. The system 100 utilizes the credentials to verify holdings in the specialized investment fund by the registered user 102. The system provides, to the registered users 102, information related to a voting item for the specialized investment fund. The system 100 receives a voting decision for the voting item from at least some of the registered users who have invested in the specialized investment fund. The system 100 conveys at least one voting decision for the voting item in the voting instructions to the asset manager.

A method includes registering user ownership of securities of a company, receiving and storing identified topics of interest from registered users, presenting the registered users with one or more voting cohort groups based on the identified topics of interest, identifying a voting item associated with the company, assigning a topic to the voting item, providing the voting item and the assigned topic to the registered users who own securities of the company, receiving, from the registered users, votes related to the voting item, identifying a voting cohort group related to the voting item, aggregating votes received from the registered users who joined the voting cohort group and determining a majority-rule vote for all shares of the company for all registered users who joined the voting cohort group, and conveying the majority-rule vote to the company.

The method may further include, based at least on the assigned topic, generating an interest score for the voting item for registered users who own securities in the company; and based on the interest scores, providing the voting item and the assigned topic to the registered users who own securities in the company. Generating the interest score for the voting item may comprise applying an algorithm that produces the interest score for the voting item for each registered user by combining data from at least one of: the registered user’s holdings, topics of interest identified by the registered user, topics identified for the voting item, registered user’s prior interactions on the system, previous discussions on the social media platform, amount of attention related to the voting item, voting deadline for the voting item, and related information from public sources. Registering user ownership of securities of the company may comprise at least one of: authenticating a user via a link issued by an investment broker that confirms purchase of securities in the company by the user; authenticating the user via a link issued by an asset manager that confirms purchase, by the user, of a fund managed by the asset manager; and authenticating the user via a link issued by a verified account aggregation service that confirms purchase of securities in the company by the user.

The method may further comprise identifying nature of ownership of the securities in the company and conveying the majority-rule vote to the company according to the nature of ownership, wherein conveying is provided via at least one of a proxy infrastructure, a ballot agent, a tally agent, asset manager for exchange traded fund or fund holding the securities in the company, and a direct mechanism to the company. Identifying the voting item associated with the company may comprise parsing voting information obtained from at least one of: a Securities and Exchange Commission filing, a website for the company, and other public notification sites for voting items. Assigning the topic to the voting item may comprise applying an artificial intelligence algorithm to identify a topic for the voting item from topics in a predetermined topic hierarchy and voting information for the voting item. The method may further comprise providing registered users with information facilitating interaction via a social media platform associated with the voting cohort group. The method may further comprise providing the social media platform; and prioritizing interactions on the social media platform by applying an algorithm that produces the interest score for the voting item for each registered user by combining data from at least one of: the registered user’s holdings, topics of interest identified by the registered user, topics identified for the voting item, registered user’s prior interactions on the system, previous discussions on the social media platform, voting deadline for the voting item, and related information from public sources. The method may further comprise restricting each registered user to one vote per voting item by limiting each registered user to one voting cohort group for each voting item. The method may further comprise providing each registered user who has joined multiple voting cohort groups associated with the voting item that the registered with a notice that the registered user’s vote may apply only to one voting cohort group of the multiple voting cohort groups or the user’s vote may be provided outside the multiple voting cohort groups. The method may further comprise accessing accounts of registered users by at least one of: authenticating, with an investment broker holding the securities of the company, over a public link by using a registered user’s credentials; authenticating, with the investment broker holding the securities of the company, over a dedicated link; and authenticating, with a third-party systems used for surveillance of investment accounts, by using the registered user’s credentials.

A method includes registering user ownership of securities of a company, receiving and storing identified topics of interest from registered users who own securities of the company, identifying a voting item associated with the company, assigning a topic to the voting item, providing the voting item and the assigned topic to the registered users who own securities of the company, receiving, from the registered users, votes related to the voting item, and conveying the received votes to the company via one or more voting agents. The method may further comprise presenting the registered users with one or more voting cohort groups based on the identified topics of interest, identifying a voting cohort group related to the voting item, aggregating votes received from the registered users who joined the voting cohort group and determining a majority-rule vote for all shares of the company for all registered users who joined the voting cohort group, and conveying the majority-rule vote to the company.

An apparatus comprises a processor and memory having stored instructions that, when executed by a processor, cause the processor to register user ownership of securities of a company, receive and storing identified topics of interest from registered users who own securities of the company, identify a voting item associated with the company, assign a topic to the voting item, provide the voting item and the assigned topic to the registered users who own securities of the company, receive, from the registered users, votes related to the voting item, and convey the received votes to the company via one or more voting agents. The instructions may further cause the processor to present the registered users with one or more voting cohort groups based on the identified topics of interest, identify a voting cohort group related to the voting item, aggregate votes received from the registered users who joined the voting cohort group and determine a majority-rule vote for all shares of the company for all registered users who joined the voting cohort group, and convey the majority-rule vote to the company. The instructions may further cause the processor to, based at least on the assigned topic, generate an interest score for the voting item for registered users who own securities in the company; and, based on the interest scores, provide the voting item and the assigned topic to the registered users who own securities in the company. Assigning the topic to the voting item may comprise applying an artificial intelligence algorithm to identify a topic for the voting item from topics in a predetermined topic hierarchy and voting information for the voting item. The instructions may further cause the processor to provide registered users who joined the voting cohort group with information facilitating interaction via a social media platform associated with the voting cohort group. The apparatus may further comprise a server for hosting a website that provides the company with the ability to participate in the system by including comments or discussions related to the company.

The methods may be performed in a different order than shown in the flowcharts and may be performed utilizing fewer or or additional processes than shown in the flowcharts. A computer-readable storage medium, which may be a non-transitory computer-readable storage medium, may have stored instructions that are operative, when executed by a processor, to cause a processor or system to perform any of the methods described herein.

The present disclosure may be embodied in other forms without departing from its spirit or essential characteristics. The described embodiments are to be considered as examples, and in all respects are merely illustrative and not restrictive.

What is claimed is:

1. A method comprising:
registering user ownership of securities of a company;
receiving and storing identified topics of interest from registered users;
presenting the registered users with one or more voting cohort groups based on the identified topics of interest;
identifying a voting item associated with the company;
assigning a topic to the voting item;
providing the voting item and the assigned topic to the registered users who own securities of the company;
receiving, from the registered users, votes related to the voting item;
identifying a voting cohort group related to the voting item;
aggregating votes received from the registered users who joined the voting cohort group and determining a majority-rule vote for all shares of the company for all registered users who joined the voting cohort group; and
conveying the majority-rule vote to the company.

2. The method of claim 1, further comprising:
based at least on the assigned topic, generating an interest score for the voting item for registered users who own securities in the company; and
based on the interest scores, providing the voting item and the assigned topic to the registered users who own securities in the company.

3. The method of claim 2, wherein generating the interest score for the voting item comprises applying an algorithm that produces the interest score for the voting item for each registered user by combining data from at least one of: the registered user’s holdings, topics of interest identified by the registered user, topics identified for the voting item, registered user’s prior interactions on the system, previous discussions on the social media platform, amount of attention related to the voting item, voting deadline for the voting item, and related information from public sources.

4. The method of claim 1, wherein registering user ownership of securities of the company comprises at least one of:
authenticating a user via a link issued by an investment broker that confirms purchase of securities in the company by the user;
authenticating the user via a link issued by an asset manager that confirms purchase, by the user, of a fund managed by the asset manager; and
authenticating the user via a link issued by a verified account aggregation service that confirms purchase of securities in the company by the user.

5. The method of claim 1, further comprising identifying nature of ownership of the securities in the company and conveying the majority-rule vote to the company according to the nature of ownership, wherein conveying is provided via at least one of a proxy infrastructure, a ballot agent, a tally agent, asset manager for exchange traded fund or fund holding the securities in the company, and a direct mechanism to the company.

6. The method of claim 1, wherein identifying the voting item associated with the company comprises parsing voting information obtained from at least one of: a Securities and Exchange Commission filing, a website for the company, and other public notification sites for voting items.

7. The method of claim 1, wherein assigning the topic to the voting item comprises applying an artificial intelligence algorithm to identify a topic for the voting item from topics in a predetermined topic hierarchy and voting information for the voting item.

8. The method of claim 1, further comprising providing registered users with information facilitating interaction via a social media platform associated with the voting cohort group.

9. The method of claim 8, further comprising:
providing the social media platform; and
prioritizing interactions on the social media platform by applying an algorithm that produces the interest score for the voting item for each registered user by combining data from at least one of: the registered user’s holdings, topics of interest identified by the registered user, topics identified for the voting item, registered user’s prior interactions on the system, previous discussions on the social media platform, voting deadline for the voting item, and related information from public sources.

10. The method of claim 1, further comprising restricting each registered user to one vote per voting item by limiting each registered user to one voting cohort group for each voting item.

11. The method of claim 10, further comprising providing each registered user who has joined multiple voting cohort groups associated with the voting item that the registered with a notice that the registered user’s vote may apply only to one voting cohort group of the multiple voting cohort groups or the user’s vote may be provided outside the multiple voting cohort groups.

12. The method of claim 1, further comprising accessing accounts of registered users by at least one of:
authenticating, with an investment broker holding the securities of the company, over a public link by using a registered user’s credentials;
authenticating, with the investment broker holding the securities of the company, over a dedicated link; and
authenticating, with a third-party systems used for surveillance of investment accounts, by using the registered user’s credentials.

13. A method comprising:
registering user ownership of securities of a company;
receiving and storing identified topics of interest from registered users who own securities of the company;
identifying a voting item associated with the company;
assigning a topic to the voting item;
providing the voting item and the assigned topic to the registered users who own securities of the company;
receiving, from the registered users, votes related to the voting item; and
conveying the received votes to the company via one or more voting agents.

14. The method of claim 13, further comprising:
presenting the registered users with one or more voting cohort groups based on the identified topics of interest;
identifying a voting cohort group related to the voting item;
aggregating votes received from the registered users who joined the voting cohort group and determining a majority-rule vote for all shares of the company for all registered users who joined the voting cohort group; and
conveying the majority-rule vote to the company.

15. An apparatus comprising:
a processor;
memory having stored instructions that, when executed by a processor, cause the processor to:
register user ownership of securities of a company;
receive and storing identified topics of interest from registered users who own securities of the company;
identify a voting item associated with the company;
assign a topic to the voting item;
provide the voting item and the assigned topic to the registered users who own securities of the company;
receive, from the registered users, votes related to the voting item; and
convey the received votes to the company via one or more voting agents.

16. The apparatus of claim 15, wherein the instructions further cause the processor to:
present the registered users with one or more voting cohort groups based on the identified topics of interest;
identify a voting cohort group related to the voting item;
aggregate votes received from the registered users who joined the voting cohort group and determine a majority-rule vote for all shares of the company for all registered users who joined the voting cohort group; and
convey the majority-rule vote to the company.

17. The apparatus of claim 15, wherein the instructions further cause the processor to:
based at least on the assigned topic, generate an interest score for the voting item for registered users who own securities in the company; and
based on the interest scores, provide the voting item and the assigned topic to the registered users who own securities in the company.

18. The apparatus of claim 15, wherein assigning the topic to the voting item comprises applying an artificial intelligence algorithm to identify a topic for the voting item from topics in a predetermined topic hierarchy and voting information for the voting item.

19. The apparatus of claim 15, wherein the instructions further cause the processor to provide registered users who joined the voting cohort group with information facilitating interaction via a social media platform associated with the voting cohort group.

20. The apparatus of claim 15, further comprising a server for hosting a website that provides the company with the ability to participate in the system by including comments or discussions related to the company.
